(19) United States
(12) Patent Application Publication
(10) Pub. No.: US 2010/0199080 A1
(43) Pub. Date: Aug. 5, 2010

(54) Method and System for Diagnosing and Programming Industrial Vehicles

(76) Inventor: Rainer Kolb, Karben (DE)

Correspondence Address: Smartpat PLC, 1581 Picadilly Dr., Troy, MI, 48084, US

(21) Appl. No.: 12/695,131

(22) Filed: Jan. 27, 2010

(30) Foreign Application Priority Data
Feb. 4, 2009 (DE) 10 2009 007 426

(51) Int. Cl. G06F 15/177; G06F 9/00; H04L 9/00

(52) U.S. Cl. 713/2; 709/222; 713/150

(57) ABSTRACT

A method and system for diagnosing and programming industrial vehicles, especially lift trucks, is provided. The method and system utilizes a computer that is connected to an area network having at least one server, e.g. the internet. The computer is also connected through an electronic interface to a lift truck's data bus.

In a first step a browser application is loaded and runs in a browser program on the computer. Thereafter, program modules and/or data are downloaded from the network server by the browser application depending on the desired vehicle diagnosis to be performed, the desired customization to be programmed, and the type and model of lift truck to be interfaced to. Downloaded program modules may comprise data that can be displayed by the browser program and applications that can be run in the browser program. The vehicle diagnosis and/or customization of control processes are performed via the data bus for the lift truck by the downloaded program module or modules.

### TECHNICAL FIELD

The present invention generally relates to a method and system for diagnosing and programming industrial vehicles. In particular, the invention relates to a method and system for diagnosing and programming customized settings in a lift truck through a computer that interfaces with the lift truck's data bus, and that is connected to a network comprising at least one server, in particular the internet.

### BACKGROUND OF THE INVENTION

Methods for remote diagnosis of lift trucks are known, in which a web server is connected to a computer via the Internet, and wherein the computer establishes a gateway to the lift truck. In this case, the diagnosis program, which requires considerable computer resources, runs on the web server. The computer connected to it, working as a client, merely provides a graphical user interface for the diagnostic program running on the web server. The client computer receives all its data from the web server and is in turn connected to the lift truck.

A disadvantage of this current technology is, that unique software must be installed for each application on the computer, must be customized for the application in question and cannot be replaced at run time in order to achieve different functionality.

In line with this current technology, a dedicated software application can be installed on the client, or the graphical interface is represented in a web browser. The disadvantage here is, that a web browser does not have direct access to the computer hardware and thus cannot connect to the lift truck's data bus.

DE 10 2005 048 762 A1 describes a remote diagnostic system and a method for the remote diagnosis of a lift truck that comprises a data bus for the transfer of a large number of parameters within the lift truck. A diagnostics module can be connected to the data bus, wherein the diagnostic module comprises a communications device for the transfer of parameters to an external diagnostic computer. The diagnostic module is designed in such way that it is possible to select a limited number of transfer parameters to be transferred with the communications device in real time to the diagnostic computer.

In one particular embodiment, a configuration for the diagnostic module and the diagnostic computer allows the selection of the parameters to be communicated to be set by means of the diagnostic computer. In a further embodiment, a customer service center can connect over a long distance to a lift truck located for example on a customer's business premises in order e.g. to analyze exceptional errors.

Therefore, in light of the problems associated with existing approaches, there is a need for an improved method and system for diagnosing and programming industrial vehicles.

### SUMMARY OF THE INVENTION

In one aspect of the present invention a computer is connected to a network, the network comprising at least one server. In particular, the network may be the Internet. The computer is further connected to an industrial vehicle's data bus through an electronic interface. The industrial vehicle may in particular be a lift truck. The computer runs a browser program, which is configured to execute a browser application.

Program modules, data, or both program modules and data are selectively loaded from a server by the browser application. Program modules and data are selectively loaded based on the vehicle model to be diagnosed, the type of diagnosis to be performed, the configuration to be programmed into the vehicle, or a combination thereof. Selectively loaded program modules may be content that is displayed in the browser program, or browser applications that are executed within the browser program, or a combination thereof. The program modules have access to the electronic interface with the vehicle's data bus, and can be used to diagnose electronic modules connected to the vehicle's data bus, or program customized parameters in the vehicle's electronic modules. Customized parameters may e.g. be those that configure a lift truck's controls processes. The vehicle diagnosis, or the customization of the control processes is performed by the downloaded program modules via the vehicle's data bus.

Time-critical applications may thereby run locally on the computer and only those program modules are downloaded that are required for a planned vehicle diagnosis, e.g. reading out error memory or evaluating stored operating times. Program modules can be downloaded selectively based on the type of lift truck. This allows minimizing the downloaded data volume of program modules. The downloaded program modules may run directly within the browser program, so that no further software installation is required.

In another aspect of the invention, a launch module is initially loaded from a first network server into the computer's memory and executed on the computer. Then a connection is established to a second network server from which browser applications are loaded. In this process, the first and second servers can be physically and logically the same machine.

While the launch module might also be preloaded on the computer, it is advantageously loaded from a network server. In particular, a launch module matching the computer's operating system and the lift truck's electronic interface can be made available via a web server in the Internet. It is not necessary for a service technician or the user to keep a large number of launch modules on hand that may no longer be up to date. Access to an up-to-date launch module is always guaranteed via the Internet.

The launch module can be terminated after the browser application has been loaded and after the browser application has been allowed to run.

In a further aspect of the invention the launch module may be able to access system routines of an operating system and hardware interfaces of a computer. The launch module may thereby establish hardware access for the browser application running within the browser program. In this aspect only the launch module requires the appropriate security permissions, for example in the firewall or as an executable program, and the download program modules can access the system routines of the operating system or the hardware interfaces of the computer indirectly via the launch module.

In yet another aspect the browser application, the program modules, data or a combination thereof may be converted into executable programs by the launch module. This prevents the program modules from conflicting with a firewall when they are downloaded.

In a further aspect a graphical representation is calculated on the computer by the browser application or an installed program module. The graphical representation may also be loaded into and generated by the browser program. This allows time-critical applications and in particular data preparation for a graphical user interface to run on the computer, allowing a considerable reduction to be achieved in the volume of data that has to be transferred from the server. Data transfer volume may be reduced by a factor 50 to 500 when compared with solutions in which vehicle diagnosis software runs predominantly on a web server and the client computer is used just for the graphical representation.

The network connection between computer and server may be established through a mobile telephone network. This allows vehicle diagnosis and customization of control processes for lift trucks to be performed almost anywhere where a mobile communications network is accessible and the computer has a corresponding modem or network access via a mobile telephone connected to it. The use of a mobile telephone network or other low bandwidth network connection is enabled by the reduced data transfer volume between computer and server. This reduction is a result of the customizing the software through the selection of matching program modules. This is a particular advantage for industrial vehicles such as e.g. lift trucks, since here, in contrast to vehicles used on public roads, maintenance and repairs must be performed on site, and the locations where lift trucks are used are spread over a wide area.

In another aspect the network server may store the protocols of the electronic interfaces as data for a number of different types of lift trucks. The server makes the protocols for the various electronic interfaces available either in a program module or in the form of data. This makes it possible to adapt to the protocol provided by the lift truck such as CAN, USB or RS232.

In a favorable embodiment, the connection over the network between the computer and server is encrypted. Thereby it is possible to protect the data concerning the operating parameters from unauthorized access when they are being transferred to the server.

The display module can run program modules independent of the operating system.

Via the launch module, program modules can be independent of an operating system.

In a favorable embodiment, all installed program components are removed or uninstalled, and downloaded data are deleted from the computer's memory after vehicle diagnosis and customization by the browser application are terminated. This allows a service technician to use the computer of a third party, e.g. a customer, since the computer can easily be returned to its previous state.

A computer program product can be loaded into memory of the computer and, running there, can perform a method as described above. The computer program product can be stored to a storage medium.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 shows schematically a prior art process of a remote diagnosis for a lift truck.

FIG. 2 illustrates a computer which is connected to a lift truck and to the Internet, implementing a method for diagnosing and programming the lift truck.

FIG. 3 schematically illustrates a software program structure.

FIG. 4 schematically illustrates the data connections according to an aspect of the present invention.

FIG. 5 schematically illustrates an alternative embodiment of a method for diagnosing and programming a lift truck.

### DETAILED DESCRIPTION

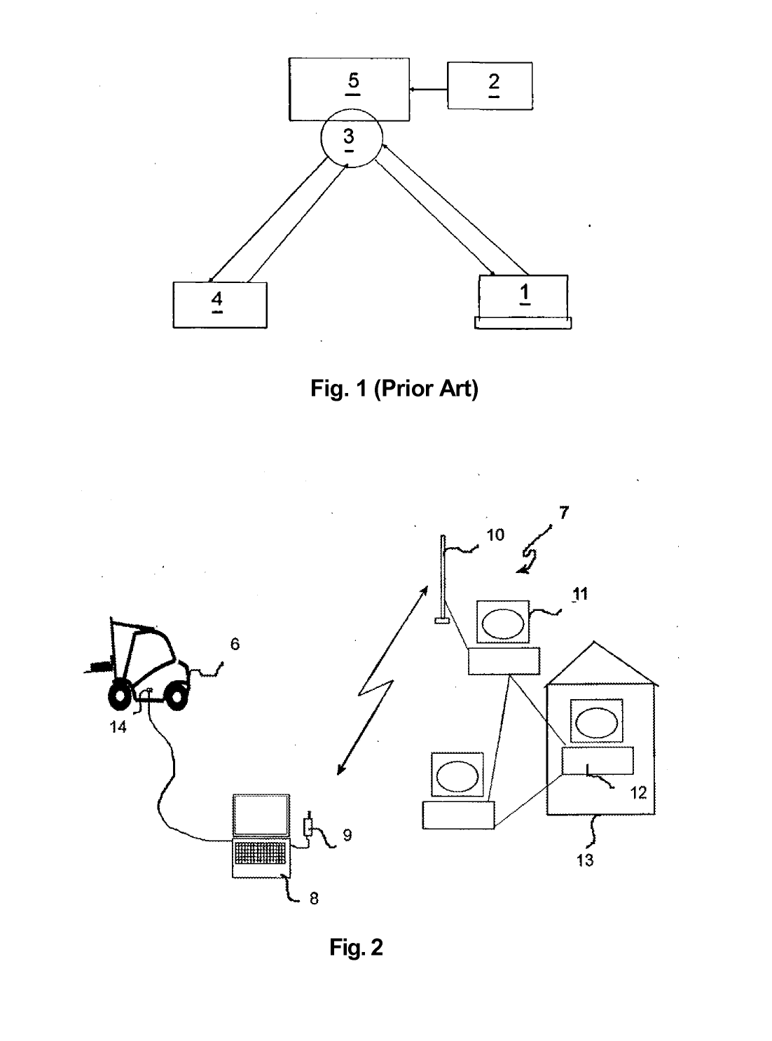

FIG. 1 shows schematically a known method to diagnose a lift truck. A personal computer (1) serves as a user interface and has a connection to the Internet or to an intranet and to a database (2), which can be located on a network server or on a DVD or hard disk. A server program (3) allows TCP/IP connections to other servers or clients. The server program (3) is designed in such a way that it can be executed on both the personal computer (1) or on other web servers, computers in the company's network, or in a hardware device (4) that enables communication between the data bus of the lift truck, e.g. CAN, serial, Ethernet, UMTS or GPRS, and the server program (3). A diagnostic program (5) provides communication, makes a user interface available, loads the diagnostic and protocol data, and accesses the database (2).

The diagnostic program (5) contains the server program (3) as a component and runs on a web server. The user interface on personal computer (1) is connected to the diagnostic program (5) via the server program (3). The hardware device (4) is addressed by the server program (3) and can communicate with the diagnostic program (5). Only the data prepared by the diagnostic program (5) are displayed on the personal computer (1).

A disadvantage is, that even for diagnostic applications that have been installed on the personal computer (1), a connection to the hardware device (4) is still not possible. Each data packet from the personal computer (1) must still be routed to the hardware device (4) via the server program (3). Also, the hardware device (4) must be a box with a permanently installed program that can establish a connection to the server program (3), or a PC program that does not change during operation. Any control operation would therefore require hardware and software that has been specially tailored.

FIG. 2 shows a lift truck, more specifically a fork-lift, (6) and a computer (8) connected to the Internet (7) in an exemplary implementation of a method and system according to an aspect of the present invention. The computer (8) is connected via a mobile telephone (9), a mobile communications receiving station (10), a mobile communications network applications server (11) and the Internet (7) to a server (12) of the fork-lift truck manufacturer (13). The computer (8) is configured as a notebook that is connected to an interface (14) of the fork-lift truck (6). The interface (14) provides the computer (8) with access to the fork-lift truck's (6) data bus. The data bus may be a CAN bus, LIN bus, USB, RS232 or any other communication bus for exchanging data between electronic control modules within an industrial vehicle. The industrial vehicle may in particular be a lift truck, a forklift, or other material handling vehicle. The industrial vehicle may also be a vehicle typically used in the farm industry, such as a tractor, harvester, or other farm vehicle. It may further be a vehicle typically used in the construction industry, such as e.g. an articulated truck, construction tractor, excavator, compactor, skidder, or other heavy equipment.

An on-site service technician with a computer (8) establishes a connection to the fork-lift truck (6) and, via the mobile telephone (9), to the Internet (7). A launch module can be downloaded from the server (12), which acts as initial server. Server (12) may e.g. be an ftp server being accesses through a TCP/IP connection. Launch modules may be executable software programs, which are provided by the ftp server. Server (12) may provide a plurality of launch modules to accommodate different operating systems on computer (8). Server (12) may e.g. provide a launch module as an executable program (.exe file) for x86 based operating systems, Wintel platforms, or executables for other operating systems including mobile devices. The launch module subsequently loads a browser application. This browser application is executed in a browser program, for example Internet Explorer, Mozilla Firefox, Google Chrome or any other browser program capable of executing browser applications. In addition, the launch module also sets up access to the hardware of computer (8). The launch module can then be terminated, and the browser application downloads additional program modules tailored to the type of fork-lift truck (6) and to the planned vehicle diagnosis and customization of the vehicle functionality. Conversely, data from fork-lift truck (6) can be transferred to server (12) for these to be analyzed there or for a remote diagnosis to be performed.

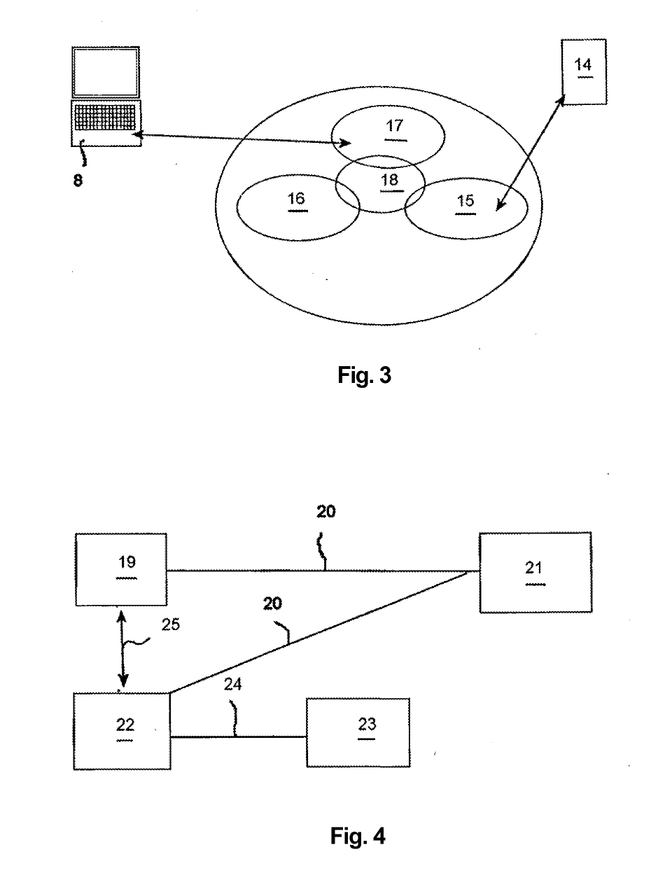

FIG. 3 shows schematically an exemplary program structure. An interface driver (15) is provided, which can address one or more protocols, e.g. RS232, USB, CAN or Bluetooth. Interface driver (15) establishes a connection with an interface (14). A protocol converter (16) is provided, and a TCP/IP server (17) is allocated to the computer (8). In addition there is the graphical user interface (GUI) (18) for interaction with a user.

FIG. 4 shows schematically the data connections in an exemplary embodiment. User interface (19) on the computer (8) communicates with database (21) on server (12) via a TCP/IP connection (20). Communications server (22) is also connected with database (21) by means of a TCP/IP connection (20). The control system (23) of the fork-lift truck (6) is operatively connected via CAN bus (24) to communications server (22). User interface (19) communicates directly with the communications server (22) via several channels (25) in real time, thus giving the user interface (19), direct access to the control system (23). The functional logic of diagnosing and programming control system (23) of fork-lift truck (6) is executed by program modules within user interface (19). Database (21) is accessed as necessary to load program modules or data into user interface (19) and enable specific diagnostic procedures to be executed.

This exemplary method describes the case, where the diagnosis runs on the computer (8) to which the lift truck (6) is connected. The launch module is only required for a computer (8) to which an interface (14) is connected. The diagnosis itself runs in the browser program, with the entire code being designed to be able run in any browser program that has a TCP/IP connection to a server.

Everything needed for the diagnosis is loaded into the browser program by the method according to an aspect of the invention. The browser program establishes the connections autonomously and communicates with the server program (3) that runs in memory when the connection is established and other connections, whether to remote servers or locally to a server program that accesses hardware and that is loaded by the launch module. At the same time, the software running in the browser program or the browser application update themselves autonomously.

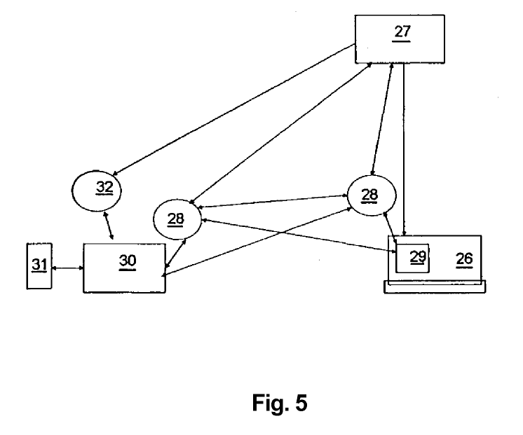

FIG. 5 shows schematically a further example of a method according to an aspect of the invention. A computer acts as an intelligent user interface (26) and uses a web browser program to load an HTML page from a server (27). The HTML page may alternatively be loaded from a data medium, e.g. a CD, DVD, or flash memory device. Subsequently, further data is loaded from server (27) or from another server. A type of graphic is displayed in the HTML page for which other, additional data, are loaded that also contain program code and that are executed in the computer's memory. This program code executes complex programs in the browser program. At the same time, the browser program can establish any number of connections to other servers and communicate with them in bi-directional mode.

The browser program can connect to one or several web servers from which it can load data or program modules. At the same time the browser program of user interface (26) can connect with one or several server programs (28) and communicate with them. The programs in the browser program can autonomously generate any type of graphics using data and loaded program parts and can display these on the screen, can receive and evaluate mouse movements and keystrokes and can analyze any type of data received via these connections, compare them with data from external servers, evaluate them, generate new data from them, and then also transmit these. The user interface (26) running in the browser program is at the same time also the diagnostic program (29). No intelligent applications or data preparation/calculation on external servers are required. The entire data preparation, the diagnostic program (29) and data management, the establishment and clearing of connections as well as the graphical preparation of data and display are performed in real time in memory and displayed on the screen. Since this only occurs in memory and in the browser program window, the process represents no risk from a security point of view.

The database (27) requires no intelligent program parts since it is controlled by the user interface (26) and can therefore be located on a DVD or on a storage medium to which the user interface (26) has access. Access to database (27) may be established via the Internet. A connection of the lift truck is established via a hardware device, here that of a laptop (30) that is connected via an additional box (31) with an interface for the vehicle's data bus. A launch module (32) loaded from the Internet and comprising approx. 400 KB of program code is executed on the laptop. The launch module (32) establishes a connection to a server program (28), transfers the control data and then downloads the required program parts depending on the hardware and becomes a server program in its own right.

These server programs can communicate with each other on several connections, exchange data simultaneously in any direction and run in memory both in the hardware device, in the Internet/extranet as well as on the computer where the user interface (26) is executed.

Each hardware device and each user interface (26) are thus directly connected with each other via server programs (28). Each user interface (26) can now control the hardware devices and e.g. the laptop (30) the user interface (26).

This architecture renders it unimportant whether all program parts run on one computer or whether a computer with user interface is situated at one location and is connected with a hardware device, e.g. a laptop (30) with add-on box (31) at a second location or with a vehicle connected via a mobile link with a server in the Internet.

This architecture makes it possible to receive all readings in parallel from the lift truck in one or several data streams, at the same time to transfer new protocols and commands to the hardware device and to display everything on the screen in virtually real time without having to wait for a response from a web server. It is also possible to represent several lift trucks simultaneously in the user interface (26) and also one or several lift trucks in one or several user interfaces and even on different computers or in different windows on one computer.

During diagnosis, a web address is called, authentication is made and then a lift truck can be selected. The connections are set up autonomously and the user has a user interface which allows the complete diagnostic program to be run applicable for the lift truck and corresponding to the user level. A program is executed for the lift truck that autonomously adapts all the data, protocols and program parts required to whatever vehicle is connected.

Both devices now search for the fastest and most efficient communications paths, autonomously load all program parts and data that they need and execute them. Only modifications and binary data without overhead are transferred in multi-directional streaming in parallel. The process on the browser program can be seen as the browser program loading several files simultaneously from several web sites and at the same time sending data to other server modules. While this happens, the software running in the browser program immediately evaluates and processes all incoming data fragments and updates all data to be transferred as well as the software running in the browser program at run time.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A method for diagnosing and programming an industrial vehicle comprising the following steps:
a) providing a computer which is operatively connected to a network, the network comprising at least one server operatively connected thereto;
b) providing an electronic interface, through which the computer is operatively connected to the industrial vehicle's data bus;
c) loading and executing a browser application in a browser program, the browser program running on the computer;
d) selectively loading program modules, data, or both, from the server into the browser program, wherein the program modules and data are selected depending on the diagnostic routing to be executed or configuration to be programmed into the industrial vehicle;
e) diagnosing the industrial vehicle or programming vehicle configuration data, wherein the diagnosing or programming is performed by the selectively loaded program modules.

2. The method according to claim 1,
wherein the industrial vehicle is a lift truck.

3. The method according to claim 1,
further comprising the step of loading a launch module into the computer's memory and executing the launch module on the computer, wherein the loading of the browser application is performed by the launch module.

4. Method according to claim 3,
wherein the launch module is loaded from a server operatively connected to the network.

5. Method according to claim 3,
wherein the launch module can access system routines of an operating system on the computer.

6. Method according to claims 3,
wherein the launch module is terminated after the step of loading and executing of the browser application has been completed.

7. Method according to claim 3,
wherein the launch module can access one or more hardware interfaces on the computer and wherein the launch module provides access to the hardware interfaces for the browser application in the browser program.

8. Method according to claim 3,
wherein the browser application, program modules, data, or a combination thereof is converted into executable programs by the launch module.

9. Method according to claim 3,
wherein a graphical representation is calculated on the computer by the browser application, or a program module, or both.

10. Method according to claim 1,
wherein access to the network is provided by a mobile communications network.

11. Method according to claim 1,
wherein the server stores and makes available to the computer protocol information of the data bus for a plurality of industrial vehicles of different types or models.

12. Method according to claim 1,
wherein the communication between the computer and the server is encrypted.

13. Method according to claim 1,
wherein the browser application, the program modules, or both, are independent of the computer's operating system.

14. Method according to claim 1,
wherein after the vehicle diagnosis and programming has been completed, the browser application and all subsequently loaded program modules and data are uninstalled and removed from the computer's memory.

15. A system for diagnosing and programming an industrial vehicle comprising:
a) a computer which is operatively connected to a network, the network comprising at least one server operatively connected thereto;
b) an electronic interface, through which the computer is operatively connected to a data bus within the industrial vehicle;
c) a browser application in a browser program, the browser program running on the computer;
wherein program modules, data, or both, are selectively loaded from the server into the browser program, and
wherein the program modules and data are selected depending on the diagnostic routing to be executed or configuration to be programmed into the industrial vehicle, and
wherein the industrial vehicles is diagnosed or industrial vehicle configuration data is programmed by the selectively loaded program modules.

16. A system for diagnosing and programming an industrial vehicle comprising:
a) a computer which is operatively connected to a network, the network comprising at least one server operatively connected thereto;
b) an electronic interface, through which the computer is operatively connected to a data bus within the industrial vehicle;
c) a launch module that is executed on the computer, the launch module comprising at least one driver which provides hardware access to the electronic interface for program modules running in a web browser program on the computer;
d) at least one program module which is selectively loaded from the server, and which is communicating with the industrial vehicle's data bus through the driver provided by the launch module.

17. A system as in claim 16, wherein the at least one program module is configured to perform a diagnostic procedure on the industrial vehicle or program a configuration into the industrial vehicle.

18. A system as in claim 16, wherein the launch module is loaded into the computer from a server through the network.
